(19) United States
(12) Patent Application Publication
(10) Pub. No.: US 2015/0192374 A1
(43) Pub. Date: Jul. 9, 2015

(54) Method of Increasing Efficiency and Reducing Thermal Loads in HVAC Systems

(71) Applicant: Russell McNeice, Hockley, TX (US)

(72) Inventor: Russell McNeice, Hockley, TX (US)

(21) Appl. No.: 14/149,631

(22) Filed: Jan. 7, 2014

(51) Int. Cl. F28F 13/18; B05D 3/10

(52) U.S. Cl. CPC F28F 13/182; B05D 3/102

(57) ABSTRACT

Generally disclosed is a method for increasing efficiency and reducing the heat stress due to climate conditions by, first cleaning and coating the coils with a Siloxane based substances; second, placing the condensing and evaporating coils in a cabinet; and finally, coating the exterior cabinet with ceramic materials.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The present application relates to the field of HVAC (Heating Ventilation, and Air Conditioning) systems.

2. Background of the Invention

HVAC systems are used to control indoor and vehicular environments. Sometimes, HVACs accomplish cooling of an indoor or vehicular environment via a refrigeration cycle. To accomplish a refrigeration cycle, many HVACs employ a compressor that circulates refrigerant gas through: (1) a finned condensing coil (i.e., fin plates coupled to tubing), where heat is rejected to the ambient air and the refrigerant gas condenses to a liquid; and (2) then through an evaporation coil where the liquid refrigerant takes heat from HVAC circulated air via evaporation of the refrigerant to a gas.

Two concerns arise in regard to HVAC systems. First, HVAC systems have a limited life cycle. Second, HVAC systems consume energy during operation and thus have operating costs. Both the life cycle and operating costs of an HVAC system are adversely affected by poor heat transfer efficiency in the condensing and evaporation coils. For instance, poor heat transfer efficiency can increase the amount of time an HVAC system must operate whereby the life cycle of the HVAC system is reduced and the operating expenses are increased. Thus, a need exists for systems and methods for increasing the heat transfer efficiency of condenser and evaporation coils.

One reason for poor heat transfer efficiency in the condensing coil is filth, since dirt and grime in the coils can act as insulation to heat transfer. Accordingly, coils are frequently cleaned. However, cleaning alone is not enough because empty space or micro cavities at the interface of the condenser coil's tube with its fin plates can readily accumulate filth or otherwise act as an insulation to heat exchange. In view of the foregoing, some have coated the fins and condenser coils with a coating so that any micro cavities at the interface of the coil and fins are filled with coating so that the fin and tubing are bonded.

Siloxane based coatings are not a new technology. For instance, Schutt (U.S. Pat. No. 6,432,191) teaches using Siloxane based coatings on a variety of different surfaces such as food containers, automobiles, and HVAC parts. Schutt et al. (U.S. Pat. No. 6,451,382) further teaches that applying Siloxane based coatings to heat exchange surfaces improve heat transfer efficiency by penetrating micro-cavities at the interface of swaged or force fit surfaces such as fins and tubes of HVAC systems. Siloxane based coatings are flexible, adherent, hydrophobic, scratch resistant, and do not degrade in acidic and alkali conditions. In HVAC systems, Siloxane establishes a mechanical and chemical bond between the condenser coil and fins so that the heat is more efficiently exchanged to the fins for dissipation to the atmosphere.

There are many Siloxane based coatings available commercially. Applying a Siloxane based coating to an HVAC system presents a unique challenge. Siloxane coatings are difficult to apply by someone untrained. Typically, a professional must apply the Siloxane coatings. Furthermore, HVAC coils must be thoroughly cleaned and properly prepared before the Siloxane is applied to the coils. Thus a need exists for systems and methods of applying Siloxane coatings to HVAC condenser coils.

One reason for poor heat transfer exchange in both the condensing and evaporating coils is ambient heat loads. Practically: a condensing coil cannot give off as much heat to the ambient if the ambient is a high temperature; and, similarly, an evaporation coil cannot take as much heat from the HVAC air if the evaporation coil is bearing ambient heat loads. As a result, a need exists for systems and methods that reduce ambient heat loads on condenser and evaporation coils of an HVAC system.

Ceramic coatings have been used on the exterior of houses and on roofing materials in order to reduce a building's heat load. For example, Haines (U.S. Pat. No. 7,157,112) teaches the use of ceramic coatings for reducing the heat load in buildings; and, Shaio, et al. (U.S. Patent Application 2013/0108873) teaches the use of ceramic coatings on roofing materials. Ceramic coatings work by reflecting sunlight and blocking the transfer of heat. Ceramic coatings can also reduce heat gain in hot sunny weather.

While ceramic coatings are commonly used for housing and roofing materials, there are very few instances of the use of ceramic coatings in HVAC systems. In one instance, Phillips (U.S. Pat. No. 7,678,434) teaches a method of using ceramics as an insultation on an air handling component in HVAC systems to insulate the HVAC air from the heat of the HVAC's compressor or other internal and motorized components. Torrey, et al. (U.S. Patent Application 2007/0020460) discloses the use of ceramic coatings in internally situated condensation pans of HVAC systems. While a few instances of using ceramic coatings on internal HVAC components exist, there currently are no known instances of the use of ceramic coatings on the exterior cabinets of HVAC systems.

### SUMMARY OF THE INVENTION

Accordingly, it is an object of the present disclosure to increase efficiency in HVAC units, particularly rooftop HVAC units. It is another object of the disclosure to reduce corrosion in HVAC units. It is another object of the present description to reduce the thermal load on HVAC units, specifically rooftop units. In one embodiment, disclosed is a method for increasing efficiency and reducing the heat stress due to climate conditions by, first cleaning and coating the coils with a Siloxane based substances; second, placing the condensing and evaporating coils in a cabinet; and finally, coating the exterior cabinet with ceramic materials. Test results indicate that when ceramic coatings are applied to such cabinets for condenser and evaporation coils, the external temperature of the cabinet is reduced by 35 to 45 degrees Fahrenheit and the internal temperature is reduced by 10 to 12 degrees Fahrenheit. Furthermore, these tests reveal that the ceramic coating removes 30 to 40% of the load on the HVAC equipment and substantially reduces run time required to satisfy internal building loads. In the tests, the addition of the ceramic coating to the cabinet of condenser and evaporation coils allows the equipment to cycle off sooner and will reduce energy consumption. Based on test results, using the disclosed methods on rooftop HVAC units reduced energy consumption by approximately 40%. The benefits of this method are reduced repair costs, increased lifespan of equipment, and reduced consumption of energy.

### BRIEF DESCRIPTION OF THE FIGURES

The manner in which these objectives and other desirable characteristics can be obtained is explained in the following description and attached figures in which:

FIG. 1 is an operational flow chart that outlines the disclosed method.

It should be noted that these figures are not intended to be limiting of the described subject matter. Instead, the figures are representative. For steps of a method, a specific order of steps is not required.

### DETAILED DESCRIPTION OF THE INVENTION

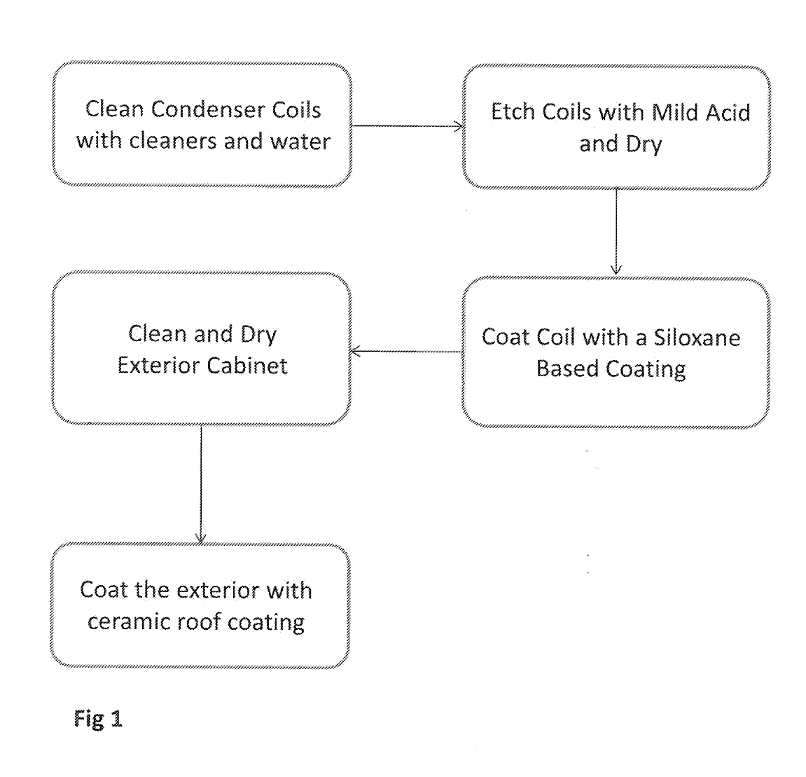

Generally disclosed is a method for increasing efficiency and reducing the heat stress due to climate conditions by: first cleaning and coating the finned condenser coils with a Siloxane based substances; second, placing the condensing and evaporating coils in a cabinet; and finally, coating the exterior cabinet with ceramic materials. The more specific details of the method are disclosed in connection with FIG. 1.

FIG. 1 is an operational flow chart that outlines the basic steps of the disclosed method. The first step is to clean the finned condenser coils. This can be done by using commercially available cleaners and water. The coils should be cleaned as many times as necessary to return the finned coils to as close to a new condition as possible. The cleaning step is necessary in order for the Siloxane coating to be effective. The next step is to etch the coils with a mild acid, such as vinegar. Etching provides a grip to which the coating may cling after application. After etching, the finned coils must be thoroughly dried. After cleaning and etching, the next step is to coat the finned coils with a thin (preferably 8 to 10 microns) layer of Siloxane based coating. One type of siloxane based coating is disclosed in U.S. Pat. No. 6,451,382 to Schultt, et al. Coating the finned coils with Siloxane provides corrosion protection and a chemical bond between the fins and piping/tubing of the condenser coil. Through thin film covalent bonding, the coating reestablishes a mechanical and chemical bond between the fin plate and tubes while providing the most efficient exchange of heat through the coil to the ambient air. By coating the coils, the internal coil pressures and electrical usage required to generate the rated cooling or heating capacity of the equipment is also reduced.

Once the Siloxane coating has been applied to the coils, the next steps involve providing a cabinet for the condensing and evaporation coils plus treating and coating the exterior of the cabinet. First, a cabinet is situated about the coils. The cabinet should be thoroughly cleaned and dried. Then the cabinet should be coated with ceramic roof coating. Preferably, the coating may be an energy star tested and rated coating. The preferred application is two coats of ceramic coating at a total dry thickness of 20 mils.

Test results indicate that when ceramic coatings are applied to such cabinets for condenser and evaporation coils, the external temperature of the cabinet is reduced by 35 to 45 degrees Fahrenheit and the internal temperature is reduced by 10 to 12 degrees Fahrenheit. Furthermore, said tests reveal that the ceramic coating removes 30 to 40% of the load on the HVAC equipment relative to uncoated HVAC systems. Furthermore, when compared HVAC systems with normal cabinets, ceramic coating on the cabinet of an HVAC system substantially reduces run time required to satisfy internal building loads. In the tests, the addition of the ceramic coating to the cabinet of condenser and evaporation coils allows the HVAC equipment to cycle off sooner and will reduce energy consumption. Based on test results on the energy consumption of un-modified HVAC systems versus HVAC systems with a ceramic coated cabinets and Siloxane coated condensation coils, using the disclosed methods on rooftop HVAC units reduced energy consumption by approximately 40%. The benefits of this method are reduced repair costs, increased lifespan of equipment, and reduced energy consumption.

### Example 1

In one embodiment used for testing, the disclosed systems and methods were incorporated into a building in Louisville, Ky. In this example: (1) a coating of Microguard® AD35 HVAC/R Coil Clear Treatment (an inorganic and reacted siloxane protective treatment) was applied to the condenser coils of a twenty five ton, high efficiency Aaon rooftop package unit; and (2) a ThermaCote™ Energy Star Ceramic Coating (a ceramic filled cabinet coating) was applied to the cabinet of the Aaon rooftop package unit. Both the coil and cabinet coatings were applied in accordance with the above disclosure. Data loggers recorded KWH consumption from Jul. 1, 2013 to Aug. 26, 2013. The recorded data was compared to KWH consumption for days in the month of July, 2013 (data collected via Standiford Field Measurements and posted to NOAA.gov) with similar temperatures. Specifically: the energy consumption on Jul. 8, 2013 (Max Temp. 90 Deg. F., Min. Temp. 69 Deg. F., Avg. Temp. 80 Deg. F.) was compared with the energy consumption on Aug. 21, 2013 (Max Temp. 90 Deg. F., Min. Temp. 69 Deg. F., Avg. Temp. 80 Deg. F.); the energy consumption on Jul. 9, 2013 (Max Temp. 91 Deg. F., Min. Temp. 77 Deg. F., Avg. Temp. 84 Deg. F.) was compared with the energy consumption on Aug. 26, 2013 (Max Temp. 90 Deg. F., Min. Temp. 71 Deg. F., Avg. Temp. 81 Deg. F.); the energy consumption on Jul. 13, 2013 (Max Temp. 85 Deg. F., Min. Temp. 64 Deg. F., Avg. Temp. 75 Deg. F.) was compared with the energy consumption on Aug. 18, 2013 (Max Temp. 85 Deg. F., Min. Temp. 64 Deg. F., Avg. Temp. 75 Deg. F.); the energy consumption on Jul. 12, 2013 (Max Temp. 83 Deg. F., Min. Temp. 63 Deg. F., Avg. Temp. 73 Deg. F.) was compared with the energy consumption on Aug. 17, 2013 (Max Temp. 84 Deg. F., Min. Temp. 66 Deg. F., Avg. Temp. 75 Deg. F.); and the energy consumption on Jul. 14, 2013 (Max Temp. 92 Deg. F., Min. Temp. 70 Deg. F., Avg. Temp. 81 Deg. F.) was compared with the energy consumption on Aug. 25, 2013 (Max Temp. 91 Deg. F., Min. Temp. 66 Deg. F., Avg. Temp. 79 Deg. F.). The data loggers for collecting data were installed and data was collected by certified technicians from Johnson Controls, Inc. In this example, the KWH energy consumption was reduced an average of forty-three and eight-tenths percent and return on investment analysis for twelve months of heating and cooling estimates resulted in an energy savings of twenty eight percent, a reduction of power costs of $0.07 and a twenty-seven and three-tenths month return on investment (seventeen and seven tenths months return on investment after taxes). Furthermore: (a) the live cycle expectancy of the condenser coil experiences a fifty percent extension relative to the coils ASHREA expected coil service life; (b) maintenance obligations are reduced; and (c) the system's carbon footprint is reduced.

### Example 2

In another embodiment used for testing, the disclosed systems and methods were incorporated into a building in Houston, Tex. In this example: (1) a coating of Microguard® AD35 HVAC/R Coil Clear Treatment (an inorganic and reacted siloxane protective treatment) was applied to the condenser coils of a three-month old, fifteen ton, high efficiency American Standard rooftop package unit; and (2) a ThermaCote™ Energy Star Ceramic Coating (a ceramic filled cabinet coating) was applied to the cabinet of the Standard American rooftop package unit. Both the coil and cabinet coatings were applied in accordance with the above disclosure. Data loggers recorded KWH consumption for two weeks prior to installation and two weeks post installation of the coatings. The recorded data from the two weeks prior to installation was compared to KWH consumption for days with similar temperatures over the two weeks post installation. Specifically: the energy consumption on May 1, 2013 (Max Temp. 81 Deg. F., Min. Temp. 64 Deg. F., Avg. Temp. 72.5 Deg. F., KWH 242) was compared with the energy consumption on May 28, 2013 (Max Temp. 84 Deg. F., Min. Temp. 69 Deg. F., Avg. Temp. 73 Deg. F., KWH 184); the energy consumption on May 9, 2013 (Max Temp. 80.1 Deg. F., Min. Temp. 71.1 Deg. F., Avg. Temp. 75.6 Deg. F., KWH 247) was compared with the energy consumption on May 27, 2013 (Max Temp. 83 Deg. F., Min. Temp. 71 Deg. F., Avg. Temp. 75 Deg. F., KWH 182); and, the energy consumption on May 11, 2013 (Max Temp. 84 Deg. F., Min. Temp. 63 Deg. F., Avg. Temp. 73.5 Deg. F., KWH 239) was compared with the energy consumption on May 15, 2013 (Max Temp. 80.6 Deg. F., Min. Temp. 66 Deg. F., Avg. Temp. 73.3 Deg. F., KWH 183). The exterior cabinet temperature was reduced from 135 Deg. F. to 92 Deg. 4. In this example, the KWH energy consumption was reduced an average of twenty-four percent and return on investment analysis for twelve months of heating and cooling estimates resulted in a seventeen months return on investment (seventeen and seven tenths months return on investment after taxes). Furthermore: (a) the live cycle expectancy of the condenser coil experiences a twenty-five to fifty percent extension relative to the coils ASHREA expected coil service life; (b) maintenance obligations are reduced; and (c) the peak energy demand of the system was reduced.

It is to be noted that appended drawings illustrate only typical embodiments of this invention, are not to scale, and therefore not to be considered limiting of its scope, for the invention may admit to other equally effective embodiments which are appreciated by those skilled in the arts. It is to be noted that appended drawings illustrate only typical embodiments of this invention, are not to scale, and therefore not to be considered limiting of its scope, for the invention may admit to other equally effective embodiments which are appreciated by those skilled in the arts.

All features disclosed in this specification, including any accompanying claims, abstract, and drawing, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step of” in the clause as specified in 35 U.S.C. §112, paragraph 6 may not be intended as a means plus claim.

The invention claimed is:

1. A method for reducing energy consumption of HVAC systems comprising:
a. Coating a condenser coil with a Siloxane based material;
b. Providing a cabinet to the condenser coil and an evaporation coil; and
c. Coating the exterior cabinet with ceramic coating.

2. A method according to claim 1 where the HVAC system is a rooftop unit.

3. A method according to claim 1 further comprising:
a. cleaning the condenser coils;
b. etching the condenser coils; and
c. applying Siloxane based material to the coils.

4. A method according to claim 3 where the HVAC system is a rooftop unit.

5. A method according to claim 3 where the ceramic coating thickness is within a range of 10 to 30 mils.

6. The method of claim 3 wherein energy consumption of the HVAC system is reduced by up to 40 percent relative to an unmodified HVAC system.

7. An HVAC unit comprising:
a finned condenser coil with a siloxane coating;
an evaporation coil;
a cabinet for said condenser and evaporation coils, wherein said cabinet is coated with a ceramic coating.
